(19) United States
(12) Patent Application Publication
(10) Pub. No.: US 2026/0287606 A1
(43) Pub. Date: Sep. 24, 2026

(54) METHOD FOR CONTROLLING A PIPETTING SYSTEM

(71) Applicant: GILSON, INC., Middleton, WI (US)

(72) Inventors: Bruno DUDEK, ORRY LA VILLE (FR); Stéphane GUICHARDON, LOUVECIENNES (FR); Fabrice MERY, CHATOU (FR)

(21) Appl. No.: 19/477,129

(22) PCT Filed: Apr. 12, 2024
(86) PCT No.: PCT/EP2024/060086

§ 371 Date: Oct. 21, 2025

(30) Foreign Application Priority Data
May 9, 2023 (FR) 2304566

(51) Int. Cl. G01N 35/10

(52) U.S. Cl. CPC G01N 35/1011

(57) ABSTRACT

Method for controlling a pipetting system having a frame with a base with a tray accommodating a consumable. A tower extends from the base and has a guide rail extending along a vertical axis. A pipetting head accommodating a pipetting channel with an end piece cooperating with a pipetting tip so as to receive or dispense liquid. The position of the pipetting head is check to obtain information representative of the position of the pipetting head relative to the base. The presence of consumable on the tray and/or pipetting tip rigidly attached to the pipetting head is checked to obtain information representative of the state of the consumable and/or pipetting tip. Pipetting procedure is controlled based on the information representative of the progress state of a pipetting protocol, information representative of the state of the consumable, and information representative of the position of the pipetting head relative to the base.

### FIELD OF THE INVENTION

The present invention relates to the field of pipetting systems, such as sampling pipettes, also referred to as pipetting systems, laboratory pipetting systems, or laboratory pipettes, or liquid transfer pipettes, intended for the sampling and for the introduction of calibrated liquid into containers.

More precisely, the invention relates to a control method capable of controlling a pipetting system. The invention preferably applies to motorized or semi-motorized pipetting systems, with manual or controlled movement of the pipetting head and motorized pipetting, but can also apply to manual pipetting systems.

The invention applies to air displacement or positive displacement pipetting systems.

### PRIOR ART

For many years, the design of pipetting systems, whether they have motorized, semi-motorized or even manual actuation, has been the object of numerous improvements.

Pipetting systems comprising a pipetting head, a base comprising one or more trays intended to come opposite the pipetting head, and a tower extending from the base and comprising a linear guide rail are known from the prior art.

Conventionally, the pipetting head comprises one or more channels, arranged on a rectangular matrix having one or more rows and one or more columns. Each of these pipetting channels is conventionally provided with an end piece intended to cooperate with a pipetting tip, which can be disposable, by fitting together so as to receive or dispense liquid.

This pipetting head can, in a known manner, be moved in translation along said linear guide rail between at least a maximum position and a minimum position. This movement of the pipetting head can be carried out manually via a user who can for example grasp the pipetting head in their hands so as to exert an upward or downward pressure in order to raise or lower the pipetting head, respectively, or fully automatically via a drive motor, the user then most often having to simply press a button or actuate a lever in order to move the pipetting head, or in a semi-motorized (or semi-manual) manner.

One disadvantage of the current pipetting systems is that they can turn out to be relatively difficult for a user to use optimally because of the number of elements to be checked before their use, the possibility that other people have previously used the pipetting system, or the possibility that a protocol implementing such a pipetting system extends over a relatively long period of time making the control of such a pipetting system complex.

There is therefore a need to improve the current situation, and in particular to implement a reliable pipetting system, as well as a control method allowing to facilitate the use of such a pipetting system and the monitoring of its use.

### DISCLOSURE OF THE INVENTION

The goal of the invention is to at least partly overcome the aforementioned disadvantages relating to the techniques of the prior art.

To do this, the invention relates to a method for controlling a pipetting system, the pipetting system comprising:
a frame comprising a base provided with at least one tray configured to accommodate at least one consumable, and a tower extending from said base and comprising a linear guide rail extending along a vertical axis V;
a pipetting head accommodating at least one pipetting channel intended to be provided with an end piece configured to cooperate with a pipetting tip so as to receive or dispense liquid, said pipetting head being translatable along said linear guide rail in at least one predefined range of movement;
means for translating said pipetting head,
a control device comprising data acquisition means and means for processing the data acquired by said acquisition means.

According to the invention, said control method comprises the following steps, implemented by said control device:
a step of checking the position of said pipetting head so as to obtain an item of information representative of a position of said pipetting head relative to said base;
a step of checking for the presence of at least one consumable on said tray and/or of at least one pipetting tip rigidly attached to said pipetting head, so as to obtain an item of information representative of a state of said at least one consumable and/or of said at least one pipetting tip;
a step of controlling a pipetting procedure, according to an item of information representative of a progress state of a pipetting protocol, said item of information representative of a state of said at least one consumable, and said item of information representative of a position of said pipetting head relative to said base.

Thus, the invention proposes a novel and inventive approach allowing to at least partly resolve the disadvantages of the prior art.

In particular, such a method for controlling a pipetting system allows a user to optimally use such a pipetting system by guiding them through their experience of use, for example by guiding them in the checking procedures prior to a pipetting procedure and then by guiding them during the pipetting protocol.

Here, pipetting protocol means a set of steps allowing to prepare, mix, dilute and/or handle one or more controlled volumes of samples or of liquid reagents.

As for the pipetting, here it designates a controlled movement of a predefined volume of liquid in a tip, connected to a pipetting head, by controlled movement of a piston according to a predefined trajectory in the pipetting chamber connected to the end piece onto which the pipetting tip is fitted.

This controlled movement of a volume of liquid can take place either in a direction corresponding to a sampling of a volume of liquid from a consumable or in a direction corresponding to a deposition of a volume of liquid in a consumable.

Here, controlled movement and controlled volume mean a precise movement of a volume of liquid, as well as a precise volume of liquid.

It should be noted that the means for translating said pipetting head can for example comprise:
a motor for translating said pipetting head, comprising a motor shaft mounted rotatably according to a motor axis stationary relative to said frame and substantially orthogonal to said vertical axis V;
a toothed pinion mounted rotatably according to said motor axis;
a movement transmission roller arranged between said motor and said toothed pinion so as to transmit a movement of rotation between said motor and said toothed pinion;
a rack mounted movably in translation according to said vertical axis V, said rack being rigidly attached to said pipetting head so as to translate it, and being arranged in contact with said toothed pinion so that a rotation of said toothed pinion causes a translation of said rack according to said vertical axis V and a translation of said rack according to said vertical axis results in a rotation of said toothed pinion.

The means for translating said pipetting head can also comprise an actuation lever mounted movably in rotation according to a horizontal axis orthogonal to said vertical axis V relative to said base, said actuation lever being configured to vertically translate said pipetting head, said actuation lever being mobile in rotation between at least a rest position and a pivoted position.

According to one aspect of at least one embodiment of the invention, the checking of the position of the pipetting head is carried out via a magnetic encoder provided with at least one magnet and a magnetometer.

According to one aspect of at least one embodiment of the invention, said step of checking for the presence of at least one consumable on said tray and/or of at least one pipetting tip rigidly attached to said pipetting head can comprise a step of checking for the presence of at least one pipetting tip fitted onto an end piece.

According to one aspect of at least one embodiment of the invention, said step of checking for the presence of at least one consumable on said tray and/or of at least one pipetting tip rigidly attached to said pipetting head comprises at least one of the following substeps:
checking the fitting of the at least one pipetting tip;
checking for the presence of a consumable on said tray;
checking for the presence and/or the position of said tray opposite said pipetting head;
in the case of presence of a consumable on said tray, checking at least one item of information characteristic of a type of consumable.

According to one aspect of at least one embodiment of the invention, said step of checking for the presence of at least one consumable on said tray and/or of at least one pipetting tip rigidly attached to said pipetting head comprises the following substeps:
checking the fitting of the pipetting tips;
checking for the presence of a consumable on said tray;
checking for the presence and/or the position of said tray opposite said pipetting head;
in the case of presence of a consumable on said tray, checking at least one item of information characteristic of a type of consumable.

According to one aspect of at least one embodiment of the invention, said step of checking for the presence of at least one consumable on said tray and/or of at least one pipetting tip secured to said pipetting head comprises the following substeps:
checking the fitting of the pipetting tips;
checking for the presence of a consumable on said tray;
checking for the presence and/or the position of said tray opposite said pipetting head;
in the case of presence of a consumable on said tray, checking at least one item of information characteristic of a type of consumable.

Such sub-steps allow to ensure that a pipetting protocol can be carried out or continued without any disturbances due to the absence of a tray or consumable in order to be able to see the protocol through to its completion.

According to one aspect of at least one embodiment of the method for controlling a pipetting system:
if said item of information representative of a position of said pipetting head relative to said base corresponds to a position of said pipetting head outside of said at least one predefined range of movement, said step of controlling a pipetting procedure comprises a step of locking at least a part of the means for translating said pipetting head;
if said item of information representative of a position of said pipetting head relative to said base corresponds to a position of said pipetting head within said at least one predefined range of movement, said step of controlling a pipetting procedure comprises at least one of the following sub-steps:
   a step of verifying said position of said pipetting head relative to at least one predetermined stop;
   a step of unlocking at least a part of the means for translating said pipetting head;
   a step of preparing the tray and/or positioning the tray;
   a pipetting step;
   a step of translating said pipetting head so as to position said pipetting head in a preparation position located outside of said predefined range of movement;
   a step of obtaining an item of information representative of a progress state of a pipetting protocol, and according to said item of information representative of a progress state of a pipetting protocol, a step of controlling a following phase of said pipetting protocol. The preparation of the tray can for example comprise the addition or the removal of consumables, reagents or samples.

The step of positioning, or moving, the tray can for example be useful in the case of a mobile tray movable axially or radially according to one, two or three axes.

The pipetting step can in particular comprise the following sub-steps:
a step of translating said pipetting head so as to fit at least one pipetting tip;
a step of translating said pipetting head so as to place a tank on the tray or position a tray comprising a tank or a microplate;
a step of translating said pipetting head so as to lower the pipetting head into the pipetting position;
a step of sucking up or dispensing liquid;
a step of translating said pipetting head so as to raise the pipetting head to remove a tank and place a target microplate or move a tray to position the microplate under the pipetting head;
a step of translating said pipetting head so as to lower the pipetting head above a microplate;
a step of ejecting the at least one pipetting tip.

It should be noted that the locking of at least a part of the drive means can for example comprise the locking of an actuation lever.

Likewise, the unlocking of at least a part of the drive means can for example comprise the unlocking of an actuation lever.

According to one aspect of at least one embodiment of the invention, if said item of information representative of a position of said pipetting head relative to said base corresponds to a position of said pipetting head within said at least one predefined range of movement, said step of controlling a pipetting procedure comprises the following sub-steps:
a step of verifying said position of said pipetting head relative to at least one predetermined stop;
a step of unlocking at least a part of the means for translating said pipetting head;
a step of preparing the tray and/or positioning the tray;
a pipetting step;
a step of translating said pipetting head so as to position said pipetting head in a preparation position located outside of said predefined range of movement;
a step of obtaining an item of information representative of a progress state of a pipetting protocol, and according to said item of information representative of a progress state of a pipetting protocol, a step of controlling a following phase of said pipetting protocol. The pipetting step can in particular comprise the following substeps:
a step of translating said pipetting head so as to fit at least one pipetting tip;
a step of translating said pipetting head so as to place a tank on the tray or position a tray comprising a tank or a microplate;
a step of translating said pipetting head so as to lower the pipetting head into the pipetting position;
a step of sucking up or dispensing liquid;
a step of translating said pipetting head so as to raise the pipetting head to remove a tank and place a target microplate or move a tray to position the microplate under the pipetting head;
a step of translating said pipetting head so as to lower the pipetting head above a microplate;
a step of ejecting the at least one pipetting tip.

According to one aspect of at least one embodiment of the invention, the control device comprises a display and input terminal, and said method comprises at least one step out of:
a step of displaying on the display and input terminal at least one item of information out of said item of information representative of a position of said pipetting head relative to said base, said item of information representative of a state of said at least one consumable, said item of information representative of a progress state of a pipetting protocol;
a step of receiving instructions from a user interacting with said display and input terminal.

According to one aspect of at least one embodiment of the invention, said item of information representative of a state of said at least one consumable belongs to the group comprising:
a number of consumables present on the tray;
a type of consumable present on the tray;
a number of tips to be fitted;
a type of tips to be fitted;
the presence and/or the position of said tray opposite the pipetting head.

According to one aspect of at least one embodiment of the invention, said item of information representative of a progress state of a pipetting protocol comprises:
a phase of said pipetting protocol previously finished;
a phase of said pipetting protocol to be carried out;
specifications of said previously finished pipetting protocol;
a waiting time before starting said pipetting protocol.
an initial item of information.

For example, specifications of the pipetting protocol can comprise a set of parameters allowing to carry out the pipetting protocol (pipetting volume, speed and direction, durations, number of pipetting cycles, target for sucking up the liquid, target for dispensing the liquid). It can also simply comprise a part of this information.

According to one aspect of at least one embodiment of the invention, the method further comprises a step of checking at least one piece of security data belonging to the group comprising:
a date of maintenance carried out or to be carried out;
an update of a service log of the pipetting system;
an action to be carried out by a user;
an item of information for identifying a user;
a command to reset said item of information representative of a progress state of a pipetting process;
a serial number;
a version of a piece of software.

According to one aspect of at least one embodiment of the invention, the control device is capable of communicating with a remote terminal.

Such a remote terminal can for example be a smartphone or a tablet. This can also be a remote server for storing downloadable protocols, a remote server for storing a configuration of pipetting system models, a remote server for storing data on use of a given pipetting system (containing for example a set of files listing the actions carried out during a protocol).

According to one aspect of at least one embodiment of the invention, the control device comprises communication means.

According to one aspect of at least one embodiment of the invention, the communication means belong to the group comprising:
a Wi-Fi antenna;
a Bluetooth antenna;
an NFC antenna;
a radio antenna.

According to one aspect of at least one embodiment of the invention, the method comprises a preliminary step of initializing the pipetting system.

The invention also relates to a pipetting system comprising:
a frame comprising a base provided with at least one tray configured to accommodate at least one consumable, and a tower extending from said base and comprising a linear guide rail extending along a vertical axis V;
a pipetting head accommodating at least one pipetting channel intended to be provided with an end piece configured to cooperate with a pipetting tip so as to receive or dispense liquid, said pipetting head being translatable along said linear guide rail in at least one predefined range of movement;
means for translating said pipetting head,
a control device comprising data acquisition means and means for processing the data acquired by said acquisition means, said pipetting device being configured to implement said control method according to one of the aforementioned embodiments.

According to a specific aspect of at least one embodiment, said acquisition means are arranged facing said tray and comprise at least one out of:
means for controlling a force of axial fitting along said vertical axis V of said at least one pipetting tip onto said at least one end piece;
a CCD or CMOS camera;
a colorimetric or photometric sensor;
an accelerometer;
an ultrasound sensor.

The implementation of an accelerometer can for example allow to monitor the positioning or the movement of one or more trays relative to the pipetting head.

The implementation of a colorimetric or photometric sensor allows to check the contents or the type of consumable present on the tray(s).

According to a specific aspect of at least one embodiment, said means for processing the acquired data comprise a microcontroller.

According to a specific aspect of at least one embodiment, said control device further comprises signaling means comprising at least one LED, an audible alarm, and/or a haptic signal.

According to a specific aspect of at least one embodiment, said control device is autonomous.

The term autonomous can be understood here as independent of the pipetting system and thus capable of being turned on and manipulated without needing to switch on the entirety of the pipetting system.

According to a specific aspect of at least one embodiment, the pipetting system comprises:
a frame comprising a base provided with at least one tray configured to accommodate at least one consumable, and a tower extending from said base and comprising at least one linear guide rail extending along a vertical axis V;
a pipetting head accommodating at least one pipetting channel intended to be provided with an end piece configured to cooperate with a pipetting tip so as to receive or dispense liquid, said pipetting head being translatable along said linear guide rail in at least one predefined range of movement between at least a maximum position forming a maximum distance from said base and a minimum position forming a minimum distance from said base;
means for translating said pipetting head comprising:
   a motor for translating said pipetting head, comprising a motor shaft mounted rotatably according to a motor axis R stationary relative to said frame and substantially orthogonal to said vertical axis V;
   a toothed pinion mounted rotatably according to said motor axis;
   a movement transmission roller arranged between said motor and said toothed pinion so as to transmit a movement of rotation between said motor and said toothed pinion;
   a rack mounted movably in translation according to said vertical axis V, said rack being rigidly attached to said pipetting head so as to translate it, and being arranged in contact with said toothed pinion so that a rotation of said toothed pinion causes a translation of said rack according to said vertical axis V and a translation of said rack according to said vertical axis results in a rotation of said toothed pinion,
control means comprising:
   means for measuring an item of information representative of said distance of said pipetting head from said base;
   means for analyzing said item of information representative of said distance of said pipetting head from said base, so as to deduce therefrom said position of said pipetting head;
   control means configured to activate said motor according to said position of said pipetting head and at least one predefined stop, said at least one predefined stop being located between said maximum position and said minimum position of the pipetting head.

By implementing control means allowing to activate and thus to power the motor simply when this is necessary and with the necessary power, it is ensured that the pipetting system is economical in terms of energy consumption. Furthermore, the wear of the components and in particular of the drive means and of the control means is thus also limited.

Moreover, this allows to provide a pipetting system that leaves broad freedom of control to a user who can predefine stops and maneuver the pipetting head within a predefined range of movement.

Finally, such a pipetting system implements control means that are relatively simple mechanically and relatively inexpensive.

According to one aspect of at least one embodiment of the invention, when said pipetting head arrives at the height of said at least one predefined stop, the control means activate said motor so as to block the translational movement of said pipetting head along said linear guide rail.

This also allows to only turn on the motor at a predefined blocking power when this is necessary and with the required power, the pipetting system thus being economical in terms of energy consumption.

According to one aspect of at least one embodiment of the invention, the measuring means comprise a magnetic encoder provided with at least one magnet and a magnetometer, said at least one magnet being fastened to said toothed pinion and being arranged opposite said magnetometer fastened to said frame of the pipetting system and configured to measure a value of a magnetic field of said at least one magnet so that a rotation of said toothed pinion about said motor axis R causes a variation in said value of said magnetic field of said at least one magnet measured by said magnetometer. Furthermore, said item of information representative of a distance of said pipetting head is measured by said magnetic encoder, and comprises a number of revolutions carried out by said toothed pinion as well as said value of the magnetic field of said at least one magnet, said analysis means deducing from said measured value of said magnetic field of said at least one magnet and from the number of revolutions carried out by said toothed pinion said position of said pipetting head.

Thus, the measuring means have an operation of the angular magnetic encoder type, with a tachometer, so as to provide measurements of value of said magnetic field of said magnet that are relatively precise and quick to obtain.

According to one aspect of at least one embodiment of the invention, said movement transmission roller has a protrusion extending along said motor axis R and about which said toothed pinion is rotatably mounted. Furthermore, said toothed pinion comprises two oblong holes symmetrical with respect to said motor axis R, said movement transmission roller having two pins protruding opposite said toothed pinion so that each of said two pins is slidingly mounted in one of said two oblong holes by movement of said movement transmission roller relative to said toothed pinion, said two pins and said motor axis R being aligned according to a plane orthogonal relative to said vertical axis V.

According to one aspect of at least one embodiment of the invention, said at least one magnet is arranged in a housing formed in said protrusion and is mounted movably in helical rotation about said motor axis R, said number of revolutions carried out by said toothed pinion depending on a distance of said magnet relative to said magnetometer.

According to one aspect of at least one embodiment of the invention, said at least one magnet is arranged on a support linked to said toothed pinion and mounted movably in rotation about an axis H stationary relative to the toothed pinion and parallel relative to said motor axis R.

According to one aspect of at least one embodiment of the invention, one of said two pins forms said axis H of rotation of said support, said axis H being parallel offset with relative to said motor axis R, said value of said magnetic field of said at least one magnet measured by said magnetometer depending on a position of each of said two pins in said two oblong holes.

According to one aspect of at least one embodiment of the invention, said measuring means are configured to detect a movement of said pipetting head by a sliding of each of said two pins in said two oblong holes from a default position in which each of said two pins is centered relative to the oblong hole in which it is slidingly mounted, and an offset position in which each of said two pins is offset with respect to the center of the oblong hole in which it is slidingly mounted. Furthermore, said control means are configured to control a speed and a direction of rotation of said motor so as to return each of said two pins to said default position.

According to one aspect of at least one embodiment of the invention, when said pipetting head arrives at the height of said at least one predefined stop, each of said two pins is stopped against an edge of said oblong hole in which it is slidingly mounted.

According to one aspect of at least one embodiment of the invention, the means for driving said pipetting head comprise at least one constant-force spring connected to said rack and configured to maintain said pipetting head in a given position.

This allows to provide stability to the pipetting head by ensuring that it is maintained in a given position, which can correspond to a position desired by a user.

According to one aspect of at least one embodiment of the invention, the device further comprises monitoring means, arranged on said pipetting head and/or on said tower and intended to be positioned facing said tray.

According to one aspect of at least one embodiment of the invention, the control means comprise monitoring means capable of delivering an item of information belonging to the group comprising:
an item of information on the presence of a support on said tray;
a number of pipetting tips not yet used;
an item of information relating to a protocol step to be carried out, ongoing, or carried out;
an item of information on date or time a pipetting protocol is carried out;
a planned maintenance date;
an item of information for identifying consumables present on the tray;
an item of information for identifying the pipetting system;
an item of information on the arrival of the pipetting head in a stopped position;
an item of information on the vertical position of the pipetting head and/or on a distance between the pipetting head and the base.

According to one aspect of at least one embodiment of the invention, said control means comprise data storage means and/or data communication means capable of communicating with a remote terminal.

According to a specific aspect of at least one embodiment of the invention, the pipetting system comprises:
a support comprising a plurality of pipetting tips, said support being arranged on a rectangular matrix of rows and columns;
a pipetting head comprising a case housing a plurality of pipetting channels arranged on a rectangular matrix of rows and columns, each of said pipetting channels being provided with an end piece intended to cooperate with one of said pipetting tips by fitting together so as to receive or dispense liquid, said pipetting head being mobile in a predefined range of movement between a raised position in which said end pieces are at a distance from said pipetting tips and an engaged position in which said pipetting tips are fitted onto said end pieces;
a base comprising at least one tray intended to come opposite said pipetting head and configured to accommodate said support provided with pipetting tips;
a tower extending from said base and comprising a linear guide rail along which the pipetting head can be manually moved along a vertical axis V relative to said base in said at least one predefined range of movement;
an actuation lever mounted movably in rotation according to a horizontal axis H orthogonal to said vertical axis V relative to said base, said actuation lever being configured to vertically translate said pipetting head between said raised position and said engaged position in response to a force applied to said actuation lever, said actuation lever being mobile in rotation between at least a rest position and a pivoted position so as to make said pipetting head go from said raised position to said engaged position;
means for controlling a force of axial fitting along said vertical axis V of said pipetting tips onto said end pieces caused by the rotation of the actuation lever between the rest position and the pivoted position.

The implementation of means for controlling a force of axial fitting together allows to improve the reliability of the pipetting system by controlling the force of fitting of the pipetting tips onto the end pieces of the pipetting head.

Indeed, such means for controlling a force of fitting together allow to ensure that a user carries out the operation of fitting the pipetting tips onto the end pieces connected to the pipetting head correctly by ensuring that the fitting together is sufficiently, but not excessively, carried out so that these tips remain in contact with the end pieces but do not deteriorate the pipetting system.

According to a specific aspect of at least one embodiment of the invention, the means for controlling a force of axial fitting along said vertical axis V of said pipetting tips onto said end pieces comprise a force sensor and a stop capable of at least partly bearing on said force sensor in response to an at least partial rotation of said actuation lever from said rest position to said pivoted position.

This allows to implement a pipetting system that is mechanically simple and simultaneously reliable.

According to a specific aspect of at least one embodiment of the invention, said tower comprises a rod for following movement of said actuation lever, said rod being connected to said actuation lever via drive means, said rod being mobile in rotation about said horizontal axis H and pivoting about said horizontal axis H in response to a force applied to said actuation lever, so that a rotation of said actuation lever from said rest position to said pivoted position causes a rotation of said rod and of said drive means from a retracted position to a position in which said rod axially bears against said stop and exerts a thrust force on said stop towards said force sensor.

According to a specific aspect of at least one embodiment of the invention, said force sensor is vertically spaced apart from said stop so that a thrust exerted by said rod on said stop is detected starting from a predetermined value of bearing of said rod on said stop.

According to a specific aspect of at least one embodiment of the invention, the system further comprises retraction means intended to move said rod away from said pipetting head, when said pipetting head is positioned outside of said predefined range of movement.

This allows to avoid that if the pipetting head is not positioned within the predefined range of movement, the retraction means move the rod away toward the rear to avoid it being able to hit for example the pipetting head and being able to damage it. It is only when the pipetting head is correctly positioned within the predefined range of movement that said rod can bear axially against said stop.

According to a specific aspect of at least one embodiment of the invention, said retracting means comprise a retraction spring configured to exert a force towards a rotation pin embodying said horizontal axis H so as to move said rod away from said pipetting head, when said pipetting head is positioned outside of said predefined range of movement. In other words, the retraction spring exerts a force against a rotation pin that formalizes the axis of rotation, and thus prevents the rotation of the shaft about said horizontal axis H when the pipetting head is positioned outside of the predefined range of movement.

According to a specific aspect of at least one embodiment of the invention, the pipetting system further comprises monitoring means, arranged on said pipetting head and intended to be positioned facing said tray.

Such monitoring means can for example comprise a CCD or CMOS camera allowing to check the number of lines of tips fitted, to check whether the consumable (which can be the support for pipetting tips, the pipetting tips, a tank, a microtitration plate) is present or absent from the tray, to check the position of the tray in the case of a multi-position tray, to check actions carried out (taking pipetting tips, presence of liquid in consumables), or even to check the type of tray installed in the case of a pipetting system having several removable or rotary trays.

According to a specific aspect of at least one embodiment of the invention, said stop is at least partially made of deformable plastic or deformable metal.

This thus allows to provide sufficient elasticity in order to allow the deformation of the stop when the rod exerts an axial force.

According to a specific aspect of at least one embodiment of the invention, the pipetting system further comprises a pipetting motor so as to receive or dispense liquid in said liquid sampling or receiving containers disposed on said tray, and to eject used pipetting tips.

This ejection of pipetting tips can be carried out by moving a plate.

According to a specific aspect of at least one embodiment of the invention, the pipetting system further comprises means for recognizing a support for pipetting tips.

According to a specific aspect of at least one embodiment of the invention, the recognition means comprise a color sensor arranged on the tower, opposite the plate.

According to a specific aspect of at least one embodiment of the invention, the pipetting system comprises tracking means capable of delivering an item of information belonging to the group comprising:
a number of pipetting tips not yet used;
an item of information relating to a protocol step to be carried out, ongoing, or carried out;
an item of information on the presence of a support on said tray;
an item of information relating to a value representative of a force of fitting together;
an item of information on date or time of carrying out of a fitting together and/or of a pipetting;
a planned maintenance date;
an item of information for identifying consumables present on the tray;
an item of information for identifying the pipetting system.

According to a specific aspect of at least one embodiment of the invention, said tracking means comprise a microcontroller and display means.

According to a specific aspect of at least one embodiment, the pipetting system is a semi-motorized pipetting system.

The invention also relates to a computer program product that can be downloaded from a communication network and/or stored on a support readable by a microprocessor and/or executable by a microprocessor, characterized in that it comprises program code instructions for executing a method for controlling a pipetting system according to one of the aforementioned embodiments, when it is executed by the device for controlling a pipetting system according to one of the aforementioned embodiments.

The invention also relates to a storage medium readable by a computer and non-transient, storing a computer program comprising a set of instructions executable by a computer or a processor to implement the method for controlling a pipetting system according to one of the aforementioned embodiments.

### PRESENTATION OF THE DRAWINGS

The invention, as well as the various advantages it has, will be more easily understood in the light of the following description of an illustrative and non-limiting embodiment thereof, and the appended drawings among which:

FIG. 1 is a diagram illustrating the method for controlling a pipetting system according to an embodiment of the invention;

FIG. 2 is a diagram illustrating the control device according to an embodiment of the invention;

FIG. 3 is a side perspective view illustrating a pipetting system according to an embodiment of the invention;

FIG. 4 is a partial side perspective view illustrating a pipetting system according to the embodiment of FIG. 3;

FIG. 5 is a partial perspective view of the other side with respect to FIG. 4, illustrating a pipetting system according to the embodiment of FIG. 3.

### DETAILED DESCRIPTION OF AN EMBODIMENT OF THE INVENTION

The principle of the invention is based on the implementation of a method for controlling a pipetting system that allows a user to optimally use such a pipetting system by guiding them through their experience of use, for example by guiding them in the checking procedures prior to a pipetting procedure and then by guiding them during the pipetting method.

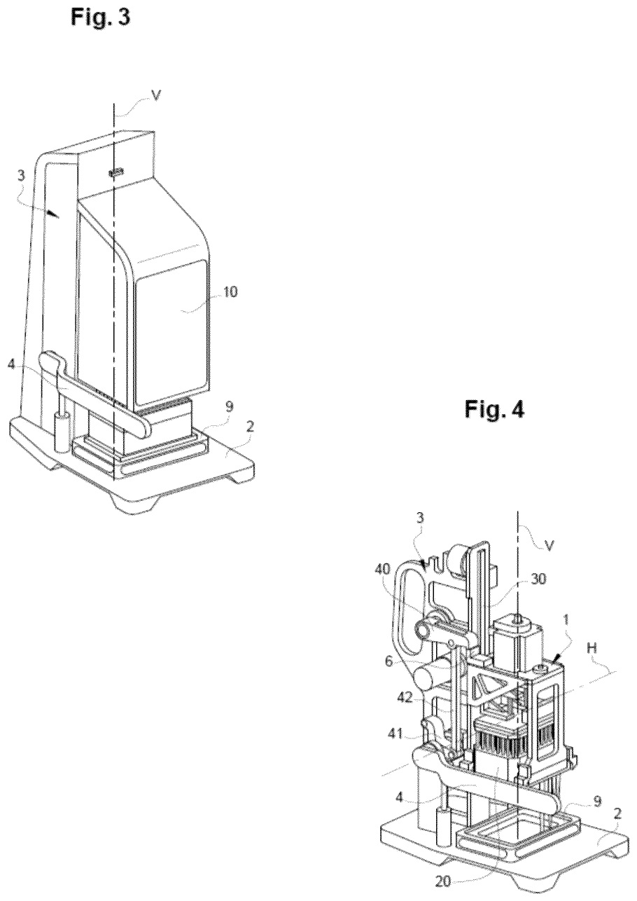

Such a method for controlling a pipetting system can for example be applied to a pipetting system as illustrated in FIGS. 3 to 5.

Such a pipetting system comprises in particular:
a frame comprising a base 2 provided with at least one tray 9 configured to accommodate at least one consumable, and a tower 3 extending from the base 2 and comprising a linear guide rail 30 extending along a vertical axis V;
a pipetting head 1 accommodating at least one pipetting channel intended to be provided with an end piece 11 configured to cooperate with a pipetting tip so as to receive or dispense liquid, the pipetting head 1 being translatable along said linear guide rail 30 in at least one predefined range of movement;
means for translating the pipetting head 1;
a control device 5 comprising data acquisition means 51 and means 52 for processing the data acquired by the acquisition means.

In this embodiment, the pipetting head also comprises a case 10 so as to protect the various components of this pipetting head from the outside environment and therefore from premature wear or breakage.

In this embodiment, and as visible in FIGS. 3 and 4, the means for translating the pipetting head 1 comprise an actuation lever 4 mounted mobile in rotation according to a horizontal axis H orthogonal to the vertical axis V relative to the base 2.

This actuation lever 4 is configured to vertically translate the pipetting head 1 and is mobile in rotation between at least a rest position and a pivoted position so as to move the pipetting head.

Even more particularly, in this embodiment, and as illustrated in FIGS. 3 and 4, the tower 3 comprises a rod 40 for following movement of the actuation lever 4, so that a rotation of the actuation lever 4 from the rest position to said pivoted position causes a rotation of the rod 40. To do this, the rod 40 is mobile in rotation about the horizontal axis H and pivots about the horizontal axis H in response to a force applied to the actuation lever 4.

This rod 40 is connected here to the actuation lever 4 via drive means 41, 42 so that a rotation of the actuation lever 4 from the rest position to the pivoted position causes a rotation of the rod 40 and of the drive means 41, 42 from a retracted position to a position in which the rod 40 bears axially.

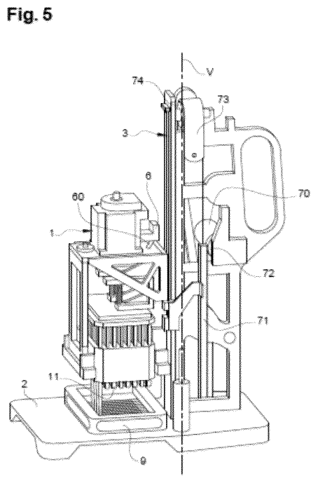

Furthermore, and as visible in FIG. 5, the means for translating the pipetting head 1 further comprise:
a motor 70 for translating the pipetting head 1, comprising a motor shaft mounted rotatably according to a motor axis, which corresponds here to the axis H, stationary relative to said frame and substantially orthogonal to said vertical axis V;
a toothed pinion 72 mounted rotatably according to the motor axis H;
a movement transmission roller 75 arranged between the motor 70 and the toothed pinion 72 so as to transmit a movement of rotation between the motor 70 and the toothed pinion 72;
a rack 71 mounted movably in translation along the vertical axis V, the rack 71 being rigidly attached to the pipetting head 1 so as to translate it, and being arranged in contact with the toothed pinion so that a rotation of the toothed pinion 72 causes a translation of the rack 71 along the vertical axis V and a translation of the rack 71 along the vertical axis causes a rotation of the toothed pinion 72.

Moreover, to accompany the movement of the pipetting head 1, and more particularly to maintain the pipetting head 1 in a given position, for example desired by a user, the means for driving the pipetting head 1 comprise at least one constant-force spring 74 comprising an axis 73 around which the spring is capable of unwinding and winding, this constant-force spring being connected to the rack 71 and configured to maintain the pipetting head 1 in a given position.

With regard to the control device 5, it is provided as autonomous in this embodiment. In other words, in this embodiment, the control device is independent of the pipetting system and can therefore be switched on and manipulated without needing to switch on the entirety of the pipetting system, for example to enter information or to become aware of information.

Thus, the control device 5 here comprises a display and input terminal 53, and comprises communication means 54 so as to communicate with a remote terminal 59.

These communication means can for example belong to the group comprising:
a Wi-Fi antenna;
a Bluetooth antenna;
an NFC antenna;
a radio antenna.

With regard to the acquisition means 51, and in this embodiment, they are arranged facing the tray 9 and comprise at least one out of:
means for controlling a force of axial fitting along said vertical axis V of said at least one pipetting tip onto said at least one end piece;
a CCD or CMOS camera;
a colorimetric or photometric sensor;
an accelerometer;
an ultrasound sensor.

In particular, the implementation of an accelerometer can for example allow to monitor the positioning or the movement of one or more trays relative to the pipetting head. Moreover, the implementation of a colorimetric or photometric sensor allows to verify the contents or the type of consumable present on the tray(s).

As for the means 52 for processing the acquired data, in this embodiment they comprise a microcontroller.

As visible in FIG. 2, the control device 5 further comprises signaling means 55 comprising at least an LED, an audible alarm, and/or a haptic signal.

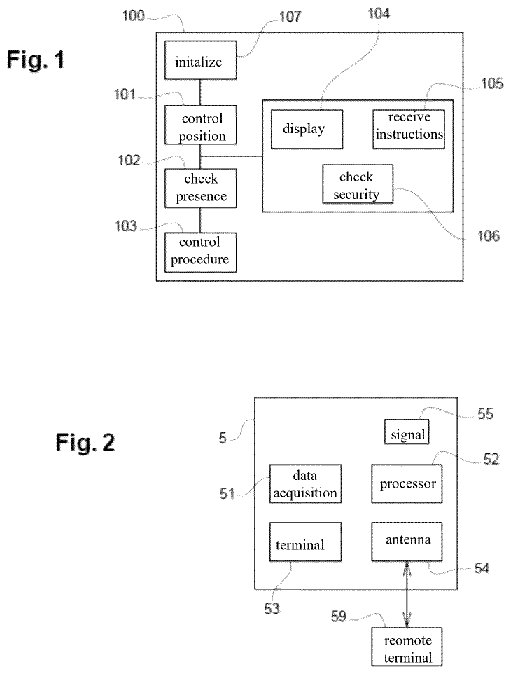

Such a control device 5 as presented above is configured to implement a method 100 for controlling a pipetting system as presented in FIG. 1.

This control method 100 comprises the following steps, implemented by the control device 5:
a step 101 of controlling the position of the pipetting head 1 so as to obtain an item of information representative of a position of the pipetting head 1 relative to the base 2;
a step 102 of checking for the presence of at least one consumable on the tray 9 and/or of at least one pipetting tip rigidly attached to the pipetting head 1, so as to obtain an item of information representative of a state of the at least one consumable and/or of the at least one pipetting tip;
a step 103 of controlling a pipetting procedure, according to an item of information representative of a progress state of a pipetting protocol, the item of information representative of a state of the at least one consumable, and the item of information representative of a position of the pipetting head relative to the base 2.

It should be noted that pipetting tip means both tips that are fitted onto the pipetting end pieces and piston capillary tips where the capillary is fitted onto the pipetting end pieces and where the piston is attached onto pistons of the pipetting head.

In the embodiment presented, the control method further comprises a preliminary step 107 of initializing the pipetting system.

Such a step can in particular allow a user to reinitialize data that is contained in the pipetting system or in the control device. This can also allow them to become aware of specificities relating to the procedure they will have to carry out.

Such a preliminary initialization step can thus for example be carried out by the control device. Thus, the method can comprise at least one step out of:
a step 104 of displaying on the display and input terminal 53 at least one item of information out of an item of information representative of a position of the pipetting head relative to the base, an item of information representative of a state of the at least one consumable, an item of information representative of a progress state of a pipetting protocol;
a step 105 of receiving instructions from a user interacting with the display and input terminal 53.

The display step can also comprise the display of other information such as:
a date of maintenance carried out or to be carried out;
an update of a service log of the pipetting system;
an action to be carried out by a user;
an item of information for identifying a user;
a command to reset said item of information representative of a progress state of a pipetting process;
a serial number;
a version of a piece of software.

These steps of displaying and receiving can also be carried out, if necessary, at other times of the method for controlling the pipetting system, for example between the step 102 of checking for the presence of at least one consumable on the tray 9 and/or of at least one pipetting tip rigidly attached to the pipetting head 1 and the step 103 of controlling a pipetting procedure.

Item of information representative of a progress state of a pipetting protocol means in this embodiment at least one item of information out of:
a phase of said pipetting protocol previously finished;
a phase of said pipetting protocol to be carried out;
specifications of said previously finished pipetting protocol;
a waiting time before starting said pipetting protocol.
an initial item of information.

During the step 101 of checking the position of the pipetting head 1, if the item of information representative of a position of the pipetting head relative to the base 2 corresponds to a position of the pipetting head outside of the predefined range of movement, the step 103 of controlling a pipetting procedure comprises a step of locking at least a part of the means for translating the pipetting head 1.

For example, the pipetting head can be positioned outside of the at least one predefined range of movement when the pipetting system is undergoing installation, cleaning or maintenance. It can also be positioned outside the at least one range of movement when the pipetting system is stopped or in standby. This position outside of the range of movement can also be used to extract pipetting tips from the support 20, or to leave a sufficient distance to install another consumable on the tray.

The locking of at least a part of the means for translating the pipetting head can for example comprise a locking of the actuation lever 4.

However, during the step 101 of checking the position of the pipetting head 1, if the item of information representative of a position of the pipetting head 1 relative to the base 2 corresponds to a position of the pipetting head 1 in the predefined range of movement, the step 103 of controlling a pipetting procedure comprises the following substeps:
a step of verifying said position of said pipetting head relative to at least one predetermined stop;
a step of unlocking at least a part of the means for translating said pipetting head;
a step of preparing the tray and/or positioning the tray;
a pipetting step;
a step of translating said pipetting head so as to position said pipetting head in a preparation position located outside of said predefined range of movement;
a step of obtaining an item of information representative of a progress state of a pipetting protocol, and according to said item of information representative of a progress state of a pipetting protocol, a step of controlling a following phase of said pipetting protocol. For example, the pipetting step can comprise one or more of the following sub-steps:
a step of translating said pipetting head so as to fit at least one pipetting tip;
a step of translating said pipetting head so as to place a tank on the tray or position a tray comprising a tank or a microplate;
a step of translating said pipetting head so as to lower the pipetting head into the pipetting position;
a step of sucking up or dispensing liquid;
a step of translating said pipetting head so as to raise the pipetting head to remove a tank and place a target microplate or move a tray to position the microplate under the pipetting head;
a step of translating said pipetting head so as to lower the pipetting head above a microplate;
a step of ejecting the at least one pipetting tip.

For example, a step of unlocking at least a part of the means for translating the pipetting head 1 can for example comprise an unlocking of the actuation lever 4.

The step of verifying said position of the pipetting head relative to at least one predetermined stop can for example be carried out via checking means (not illustrated) comprising:
means for measuring an item of information representative of the distance of said pipetting head from the base;
means for analyzing the item of information representative of the distance of the pipetting head from the base, so as to deduce therefrom the position of the pipetting head, and thus verify this position of the pipetting head relative to at least one predetermined stop.

The measuring means can for example comprise a magnetic encoder provided with at least one magnet and a magnetometer, the at least one magnet being fastened to the toothed pinion 72 and being arranged opposite the magnetometer fastened to the frame of the pipetting system and configured to measure a value of a magnetic field of the at least one magnet so that a rotation of the toothed pinion 72 about the motor axis H causes a variation in the value of the magnetic field of the at least one magnet measured by the magnetometer. Thus, the distance of the pipetting head is measured by said magnetic encoder, and comprises a number of revolutions carried out by the toothed pinion 72 as well as the value of the magnetic field of the at least one magnet, the analysis means deducing from the measured value of the magnetic field of the at least one magnet and from the number of revolutions carried out by the toothed pinion 72 said position of the pipetting head, potentially relative to at least one predefined stop.

As for the step of translating the pipetting head 1 so as to fit pipetting tips, it can be carried out using means for controlling a force of axial fitting along the vertical axis V of the pipetting tips onto said end pieces, caused by the rotation of the actuation lever 4 between the rest position and the pivoted position. Such means for controlling a force of fitting together can allow to ensure the sealing of these tips relative to these end pieces, but also to ensure that when being fitted, the tips do not deteriorate the end pieces by incorrect handling by a user. Thus, the implementation of means for controlling a force of axial fitting together can allow to implement a reliable pipetting system that allows to control the force of fitting of the pipetting tips onto the end pieces of the pipetting head by ensuring that the fitting together is carried out sufficiently, but not excessively, so that the pipetting tip(s) remain in contact with the end pieces but do not deteriorate the pipetting system.

These means for controlling a force of axial fitting together along the vertical axis V can for example comprise a force sensor 60 and a stop 6, illustrated more particularly in FIG. 4, capable of at least partially bearing on the force sensor 60 in response to at least partial rotation of the actuation lever 4 from the rest position to the pivoted position. According to one alternative, if the item of information representative of a position of the pipetting head relative to the base corresponds to a position of the pipetting head within the predefined range of movement, the step of controlling a pipetting procedure could comprise at least one of the following sub-steps:
a step of verifying said position of the pipetting head relative to at least one predetermined stop;
a step of unlocking at least a part of the means for translating the pipetting head;
a step of preparing the tray and/or positioning the tray;
a pipetting step;
a step of translating said pipetting head 1 so as to position the pipetting head in a preparation position located outside of the predefined range of movement;
a step of obtaining an item of information representative of a progress state of a pipetting protocol, and according to the item of information representative of a progress state of a pipetting protocol, a step of controlling a following phase of said pipetting protocol.

The pipetting step can in particular comprise the following substeps:
a step of translating said pipetting head so as to fit at least one pipetting tip;
a step of translating said pipetting head so as to place a tank on the tray or position a tray comprising a tank or a microplate;
a step of translating said pipetting head so as to lower the pipetting head into the pipetting position;
a step of sucking up or dispensing liquid;
a step of translating said pipetting head so as to raise the pipetting head to remove a tank and place a target microplate or move a tray to position the microplate under the pipetting head;
a step of translating said pipetting head so as to lower the pipetting head above a microplate;
a step of ejecting the at least one pipetting tip.

With regard to the step 102 of checking for the presence of at least one consumable on said tray and/or of at least one pipetting tip fitted onto an end piece 11, it comprises in this embodiment the following sub-steps:
checking the fitting of the pipetting tips, which can also be carried out using the means for controlling a force of fitting together as presented previously;
checking for the presence of a consumable on the tray 9;
checking for the presence and/or the position of the tray 9 opposite the pipetting head;
in the case of presence of a consumable on the tray 9, checking at least one item of information characteristic of a type of consumable.

Such sub-steps allow to ensure that a pipetting protocol can be carried out or continued without any disturbances due to the absence of a tray or consumable in order to be able to see the protocol through to its completion.

However, according to another embodiment, said step of checking for the presence of at least one consumable on said tray and/or of at least one pipetting tip rigidly attached to said pipetting head could comprise at least one of the following sub-steps:
checking the fitting of the pipetting tips;
checking for the presence of a consumable on said tray;
checking for the presence and/or the position of said tray opposite said pipetting head;
in the case of presence of a consumable on said tray, checking at least one item of information characteristic of a type of consumable.

Furthermore, according to another alternative, said step of checking for the presence of at least one consumable on said tray and/or of at least one pipetting tip rigidly attached to said pipetting head could comprise at least two of the following substeps:
checking the fitting of the pipetting tips;
checking for the presence of a consumable on said tray;
checking for the presence and/or the position of said tray opposite said pipetting head;
in the case of presence of a consumable on said tray, checking at least one item of information characteristic of a type of consumable.

Furthermore, according to another alternative, said step of checking for the presence of at least one consumable on said tray and/or of at least one pipetting tip rigidly attached to said pipetting head could comprise at least three of the following sub-steps:
checking the fitting of the pipetting tips;
checking for the presence of a consumable on said tray;
checking for the presence and/or the position of said tray opposite said pipetting head;
in the case of presence of a consumable on said tray, checking at least one item of information characteristic of a type of consumable.

It should be noted that, in this embodiment, the item of information representative of a state of the at least one consumable belongs to the group comprising:
a number of consumables present on the tray;
a type of consumable present on the tray;
a number of tips to be fitted;
a type of tips to be fitted;
the presence and/or the position of the tray opposite the pipetting head.

According to the embodiment illustrated, the method further comprises a step 106 of checking at least one piece of security data belonging to the group comprising:
a date of maintenance carried out or to be carried out;
an update of a service log of the pipetting system;
an action to be carried out by a user;
an item of information for identifying a user;
a command to reset said item of information representative of a progress state of a pipetting process;
a serial number;
a version of a piece of software.

The invention also relates to a computer program product that can be downloaded from a communication network and/or stored on a support readable by a microprocessor and/or executable by a microprocessor, characterized in that it comprises program code instructions for executing a method for controlling a pipetting system according to one of the aforementioned embodiments, when it is executed by the device for controlling a pipetting system according to one of the aforementioned embodiments.

The invention also relates to a storage medium readable by a computer and non-transient, storing a computer program comprising a set of instructions executable by a computer or a processor to implement the method for controlling a pipetting system according to one of the aforementioned embodiments.

1-15. (canceled)

16. A method for controlling a pipetting system, the pipetting system comprising:
a frame comprising a base provided with at least one tray configured to accommodate at least one consumable, and a tower extending from the base and comprising a linear guide rail extending along a vertical axis;
a pipetting head accommodating at least one pipetting channel provided with an end piece configured to cooperate with a pipetting tip so as to receive or dispense a liquid;
a translating device to translate the pipetting head along the linear guide rail in at least one predefined range of movement; and
a controller comprising a data acquisition device and a processor to process data acquired by the data acquisition device;
the method implemented by the controller comprising:
position checking a position of the pipetting head so as to obtain an item of information representative of a position of the pipetting head relative to the base;
presence checking for a presence of at least one the following: at least one consumable on said at least one tray and at least one pipetting tip rigidly attached to the pipetting head, so as to obtain an item of information representative of a state of the consumable and pipetting tip; and
controlling a pipetting procedure, according to an item of information representative of a progress state of a pipetting protocol, the item of information representative of the state of the consumable and pipetting tip, and the item of information representative of the position of the pipetting head relative to said base.

17. The method of claim 16, wherein the presence checking further comprises at least one of the following:
checking a fitting of said at least one pipetting tip;
checking for a presence of a consumable on said at least one tray;
checking for a presence of said at least one tray opposite the pipetting head;
checking for a position of said at least one tray opposite the pipetting head; and
in response to a determination that the consumable is present on said at least one tray, checking at least one item of information characteristic of a type of the consumable.

18. The method of claim 16, wherein:
in response to a determination that the item of information representative of the position of the pipetting head relative to the base corresponds to a position of the pipetting head outside of said at least one predefined range of movement, the controlling the pipetting procedure further comprises locking at least a part of the translating device; and
in response to a determination that the item of information representative of the position of the pipetting head relative to the base corresponds to a position of the pipetting head within said at least one predefined range of movement, the controlling the pipetting procedure further comprises at least one of the following:
verifying the position of the pipetting head relative to at least one predetermined stop;
unlocking at least said part of the translating device;
preparing said at least one tray;
positioning said at least one tray;
pipetting;
translating the pipetting head so as to position the pipetting head in a preparation position located outside of said at least one predefined range of movement; and
obtaining the item of information representative of the progress state of the pipetting protocol, and controlling a subsequent phase of the pipetting protocol based on the item of information representative of the progress state of the pipetting protocol.

19. The method of claim 18, wherein the pipetting comprises:
translating the pipetting head so as to fit the pipetting tip;
translating the pipetting head so as to place a tank on said at least one tray or position said at least one tray comprising a tank or a microplate;
translating the pipetting head so as to lower the pipetting head into a pipetting position;
sucking up or dispensing the liquid;
translating the pipetting head so as to raise the pipetting head to remove the tank and place the microplate or to move said at least one tray to position the microplate under the pipetting head;
translating the pipetting head so as to lower the pipetting head above the microplate; and
ejecting the pipetting tip.

20. The method of claim 16, wherein the controller further comprises a display and input terminal, and further comprises at least one of:
displaying on the display and input terminal at least one of the following: the item of information representative of the position of the pipetting head relative to the base, the item of information representative of the state of the consumable and pipetting tip, and the item of information representative of the progress state of the pipetting protocol; and
receiving instructions from a user interacting with the display and input terminal.

21. The method of claim 16, wherein the item of information representative of the state of the consumable and pipetting tip belongs to a group comprising:
a number of consumables present on said at least one tray;
a type of consumable present on said at least one tray;
a number of tips to be fitted;
a type of tips to be fitted; and
at least one of a presence of said at least one tray opposite the pipetting head and a position of said at least one tray opposite the pipetting head.

22. The method of claim 16, wherein the item of information representative of the progress state of the pipetting protocol comprises:
a phase of a previously completed pipetting protocol;
a phase of a pipetting protocol to be performed;
specifications of the previously completed pipetting protocol;
a waiting time before starting the pipetting protocol; and
an initial item of information representative of the progress state of the pipetting protocol.

23. The method of claim 16, further comprises checking at least one piece of security data belonging to a group comprising:
a date of maintenance performed or to be performed;
an update of a service log of the pipetting system;
an action to be performed by a user;
an item of information to identify by the user;
a command to reinitialize the item of information representative of the progress state of the pipetting protocol;
a serial number; and
a version of a piece of software.

24. The method of claim 16, further comprising initializing the pipetting system prior to the steps of positing checking, presence checking and controlling the pipetting procedure.

25. A pipetting system configured to implement the method of claim 16, comprising:
a frame comprising a base provided with at least one tray configured to accommodate at least one consumable, and a tower extending from the base and comprising a linear guide rail extending along a vertical axis;
a pipetting head accommodating at least one pipetting channel provided with an end piece configured to cooperate with a pipetting tip so as to receive or dispense a liquid, the pipetting head being translatable along the linear guide rail in at least one predefined range of movement;
a translating device to translate said pipetting head along the linear guide rail in said at least one predefined range of movement; and
a controller comprising a data acquisition device and a processor to process data acquired by the data acquisition device.

26. The pipetting system of claim 25, wherein the data acquisition device is arranged facing said at least one tray and further comprises at least one of the following:
a force controller to control a force of an axial fitting along the vertical axis of said at least one pipetting tip onto said at least one end piece;
a charge-coupled device (CCD) or complementary metal-oxide-semiconductor (CMOS) camera;
a colorimetric or photometric sensor;
an accelerometer; and
an ultrasound sensor.

27. The pipetting system of claim 25, wherein the processor comprises a microcontroller.

28. The pipetting system of claim 25, wherein the controller further comprises a signal generator comprising at least one of an LED, an audible alarm, and a haptic signal.

29. The pipetting system of claim 25, wherein the controller is autonomous.

30. A computer program product downloadable from a communication network by a microprocessor, the computer program product comprising program code instructions for executing the method of claim 16 by the pipetting system.

31. A computer program product stored in a non-transitory computer readable storage medium, the computer program product comprising program code instructions for executing a method of claim 16 by the pipetting system.

32. A non-transient storage medium readable by a computer and comprising a set of instructions executable by the computer or the processor to implement the method for controlling the pipetting system of claim 16.
